(19) United States
(12) Patent Application Publication
(10) Pub. No.: US 2024/0400394 A1
(43) Pub. Date: Dec. 5, 2024

(54) MULTIDIMENSIONAL 3D GRAPHENE-BASED HIGH-PERFORMANCE CATALYSTS

(71) Applicant: Carnegie Mellon University, Pittsburgh, PA (US)

(72) Inventors: Itzhaq Cohen-Karni, Pittsburgh, PA (US); Raghav Garg, Pittsburgh, PA (US); Daniel J. San Roman, Pittsburgh, PA (US); Inkyu Lee, Pittsburgh, PA (US); Yingqiao Wang, Pittsburgh, PA (US); Samuel Gershanok, Pittsburgh, PA (US); Mabel Bartlett, Pittsburgh, PA (US); Xudong Ji, Pittsburgh, PA (US); Jonathan Rivnay, Pittsburgh, PA (US)

(73) Assignee: Carnegie Mellon University, Pittsburgh, PA (US)

(21) Appl. No.: 18/700,522

(22) PCT Filed: Oct. 13, 2022
(86) PCT No.: PCT/US2022/046617

§ 371 Date: Apr. 11, 2024

Related U.S. Application Data
(60) Provisional application No. 63/255,136, filed on Oct. 13, 2021.

(51) Int. Cl. C01B 32/186; C01B 32/194

(52) U.S. Cl. CPC C01B 32/186; C01B 32/194; C01P 2004/03; C01P 2004/04; C01P 2004/80

(57) ABSTRACT

A hybrid graphene material includes a functional group to expand the use of graphene in various applications. The hybrid material may include a substrate, such as silicon nanowires, where the graphene is fabricated on the surface of the substrate with an out-of-plane topography. Functional groups can be added to the graphene and affect the electrical, chemical, or photo characteristics of the hybrid material.

### CROSS-REFERENCE TO RELATED APPLICATIONS

This application claims the benefit under 35 U.S.C. § 119 of U.S. Provisional Application Ser. No. 63/255,136, filed on Oct. 13, 2021, which is incorporated herein by reference.

### STATEMENT REGARDING FEDERALLY SPONSORED RESEARCH

This invention was made with U.S. Government support under D20AC00002 awarded by the Defense Advanced Research Projects Agency. The U.S. Government has certain rights in this invention.

### BACKGROUND OF THE INVENTION

The present disclosure generally relates to a hybrid graphene material. More specifically, the disclosure relates to a graphene material synthesized on a substrate and functionalized for use in various applications, from electrocatalysis to biosensing. Further disclosed are methods of fabricating the material, including the use of a plasma enhanced chemical vapor deposition process.

Graphene is a promising material with many potential applications due to its superior mechanical, electrical, and chemical properties. Various processes have been disclosed to fabricate graphene, such as physical vapor deposition, chemical vapor deposition, sputtering, and atomic layer deposition. In one example process, graphene is deposited on a nanostructure substrate in a plasma enhanced chemical vapor deposition process, forming a hybrid material. Using this process, the hybrid material has an out-of-plane topography and includes single-to-few layer graphene flakes free-standing on the substrate. Due to the out-of-plane topography, this material has been referred to as fuzzy graphene or, with the use of a substrate, nanowire-templated three-dimensional fuzzy graphene. The morphological characteristics of the hybrid material can be controlled by tuning the synthesis parameters, such as temperature, time, precursor concentration, plasma power, and template architecture. Despite recent improvements, it is still difficult to control morphology, particularly when pre- or post-treating the graphene or modifying the synthesis conditions to permit functionalization of the graphene. Functionalization of the graphene is useful in applications ranging from bioelectronics to electrocatalysis. Therefore, it would be advantageous to develop an improved functionalized hybrid graphene material and process of synthesizing the hybrid material to permit utilization in a range of applications.

### BRIEF SUMMARY

According to embodiments of the present disclosure is a functionalized hybrid graphene material. Functionalization may occur on the graphene, which comprises a plurality of single- to few-layer graphene flakes extending out of plane from a substrate. Functionalization permits use of the graphene in electrocatalysis and biosensing, among other applications. Various fabrication techniques can be used to create the hybrid graphene material, including chemical vapor deposition.

### BRIEF DESCRIPTION OF THE SEVERAL VIEWS OF THE DRAWINGS

FIG. 1 is a schematic representing nanowire templated 3D fuzzy graphene.

FIG. 2 are scanning electron microscope images of 3D fuzzy graphene.

FIG. 3 is a high-resolution transmission electron microscopy image of nanowire templated 3D fuzzy graphene.

FIG. 4 is a graph showing the number of flake edges formed under various synthesis conditions.

FIG. 5 is a schematic representing an oxygen reduction reaction occurring on nanowire templated 3D fuzzy graphene.

FIG. 6 is an image of nanowire templated 3D fuzzy graphene ultra-microelectrodes.

FIG. 7A is a schematic illustrating a convention two-dimensional electrode and a nanowire templated 3D fuzzy graphene electrode.

FIG. 7B is a scanning electron microscope image of a microfabricated 20 μm nanowire templated 3D fuzzy graphene electrode.

FIG. 7C shows scanning electron microscope images of nanowire templated 3D fuzzy graphene (left) and nanowire templated 3D fuzzy graphene functionalized with PEDOT:PSS.

FIG. 8 is a graph of Raman spectra showing differences between a hybrid graphene material and one functionalized with PEDOT:PSS.

FIGS. 9A-9B are graphs shows various performance characteristics of functionalized hybrid graphene materials.

FIG. 10 is an image of a functionalized hybrid graphene material.

FIG. 11 is a graph comparing sensing capabilities of a hybrid graphene material and a functionalized hybrid graphene material.

FIGS. 12A-12B are schematics of a process for functionalizing hybrid graphene materials with silicon.

FIG. 13 is a scanning electron microscope image of nanowire templated 3D fuzzy graphene functionalized with silicon.

FIG. 14 is a diagram of the energy band for a graphene/silicon junction in a functionalized hybrid graphene material.

### DETAILED DESCRIPTION

According to embodiments of the disclosure is a functionalized hybrid graphene material 100. The functionalization of graphene expands the potential uses and applications for graphene, including electrocatalyst and biochemical sensing, among others.

### NT-3DFG Structure and Properties

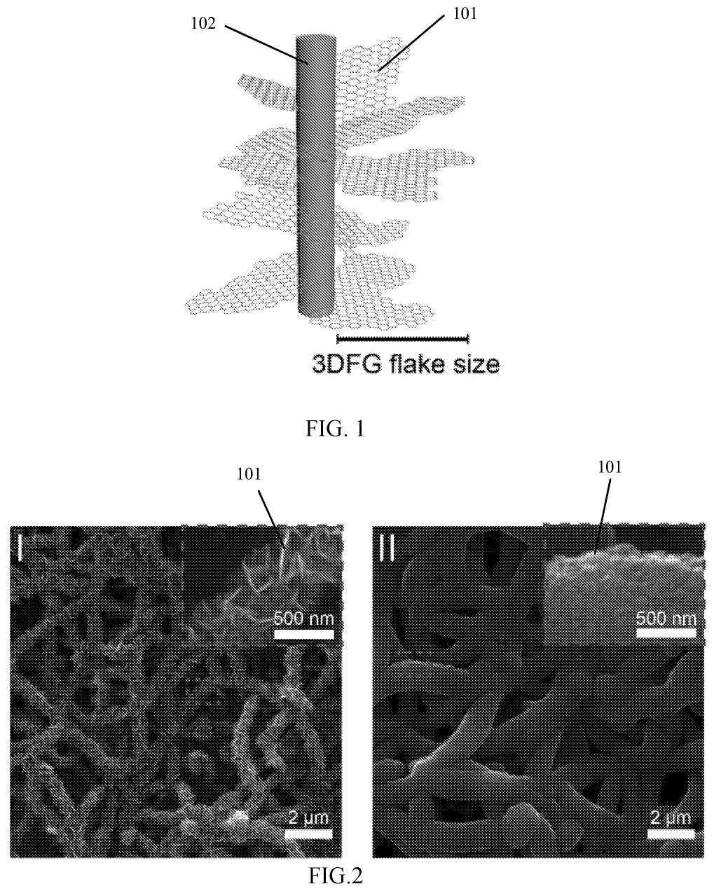

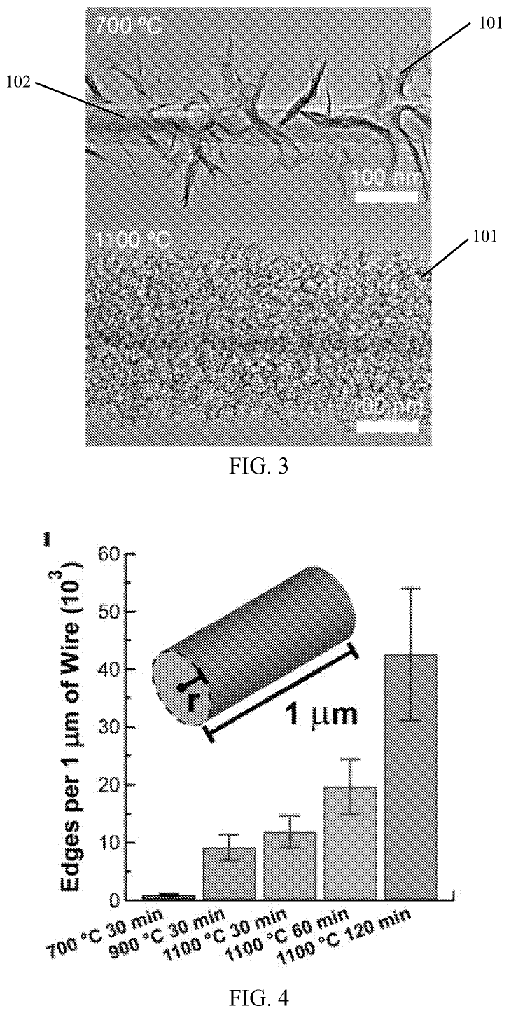

Nanowire templated-3D fuzzy graphene (NT-3DFG) is a multi-dimensional hybrid-nanomaterial comprising three dimensionally (3D) arranged graphene flakes 101 on the surface of one-dimensional Si nanowires (SiNWs) used as a substrate 102. In addition to silicon nanowires, the substrate 102 may comprise fibers or similar materials that are metallic, insulating, or semiconducting. A representation of this hybrid graphene material 101 is shown in FIG. 1. As shown in FIG. 1, the NT-3DFG comprises free-standing 3D fuzzy graphene flakes 101 on a Si nanowire core 102. NT-3DFG is synthesized following a two-step chemical vapor deposition (CVD) scheme. First, the SiNW template 102 is synthesized through Au nanoparticles (AuNPs) catalyzed vapor-liquid-solid (VLS) process and 3DFG 101 is directly synthesized on the SiNWs template 102 though inductively coupled plasma enhanced chemical vapor deposition with a CH₄ precursor. The parameters of the synthesis process can be used to control the structure of NT-3DFG. For example, morphological properties, such as graphene flake size and edge density, can be controlled by altering the partial pressure of the CH₄ precursor, synthesis time, synthesis temperature, and plasma power. FIG. 2 shows scanning electron microscopy images of NT-3DFG mesh synthesized at 700° C. for 30 minutes (left) and 1100° C. for 30 minutes (right). The insets in FIG. 2 present out-of-plane graphene 101 on the SiNW substrate 102. FIG. 3 is a representative high-resolution transmission electron microscopy images of NT-3DFG synthesized at 700° C. (top) and 1100° C. (bottom) for 10 min. FIG. 4 shows the number of flake edges along a 1 μm length of the nanowire of radius r for five synthesis conditions. NT-3DFG diameter is a function of at least CH₄ partial pressure (10 min. plasma enhanced chemical vapor deposition (PECVD) process time) and PECVD process time (under 25.0 mTorr CH₄ partial pressure).

The unique structure of NT-3DFG affects its electrical, thermal, optical, photothermal, and electrochemical properties. For example, the free-standing graphene flakes 101 enhance the optical absorption and photothermal response due to light-trapping effects. The exposed edges of the graphene flakes 101 are catalytically active and can be engineered by synthesis conditions. Finally, since the basal planes of both sides of the graphene 101 are exposed, the material exhibits superior electrochemical surface area.

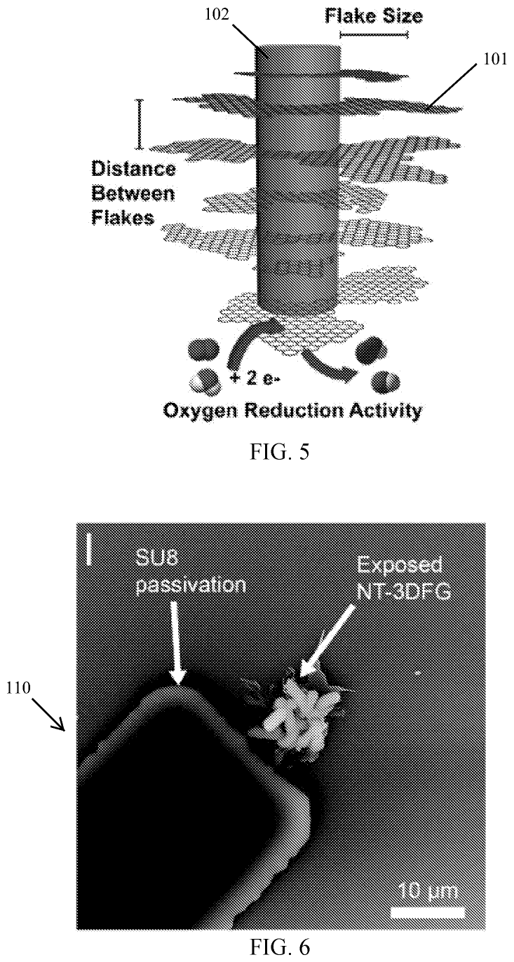

If these properties can be controlled, the uses of NT-3DFG can be expanded beyond current applications. Such expanded uses can range from catalysis to bioelectronics. In one example, the edge density in NT-3DFG is optimized for metal free H₂O₂ electrocatalysis with high efficiency (onset potential of 0.79±0.01 V versus reversible hydrogen electrode (RHE) and selectivity (94±2% Faradaic efficiency towards H₂O₂)). FIG. 5 shows an oxygen reduction reaction with NT-3DFG. In addition, the high electrochemical surface area of NT-3DFG also exhibits high electrochemical capacitance. This results in extremely low electrode impedances and allows the development of 3DFG and NT-3DFG ultramicroelectrodes for electrophysiology recordings with high signal-to-noise ratio (SNR). FIG. 6 shows a scanning electron microscopy image of a 10 m NT-3DFG ultra-microelectrode 110 that can be used for sub-cellular electrical recordings. The unique properties of NT-3DFG can be utilized in real-time electrochemical sensing with high sensitivity and selectivity of biomolecules, such as dopamine. Finally, the high absorbance of NT-3DFG in broadband provides a powerful toolset for remote, photothermal modulation of electrophysiology with laser energies as low as sub-hundred nanojoules. The required incident energy to achieve the modulation is much lower than SiNWs.

Templating Conductive Polymer onto 3DFG and NT-3DFG

Other nanostructured carbon platforms have severe drawbacks due to the lack of control over material morphology and flexibility for functionalization. The highly controllable structure, versatility, and chemical stability of 3DFG allows for chemical modification and composition via electro-polymerization.

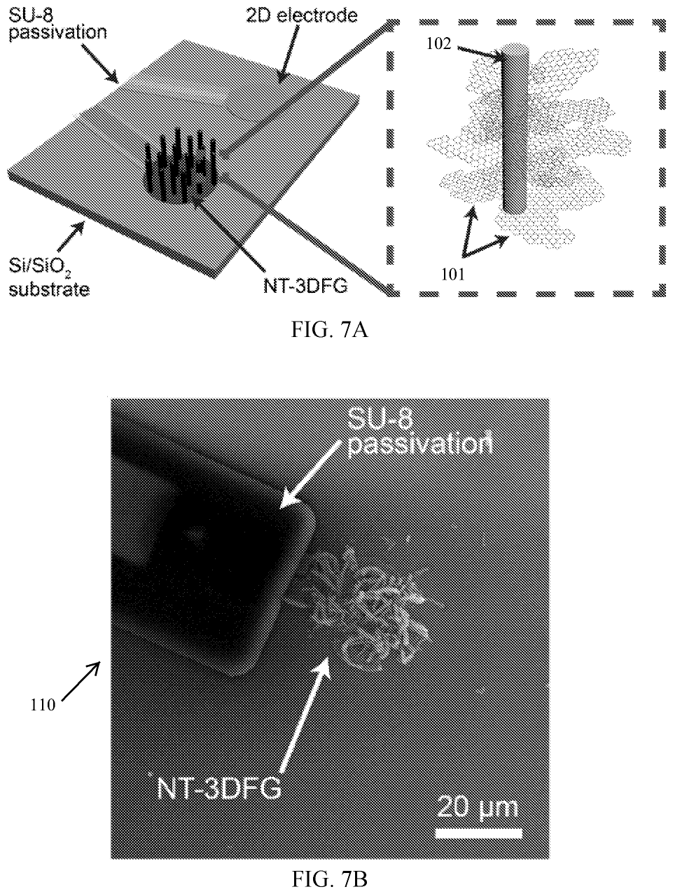

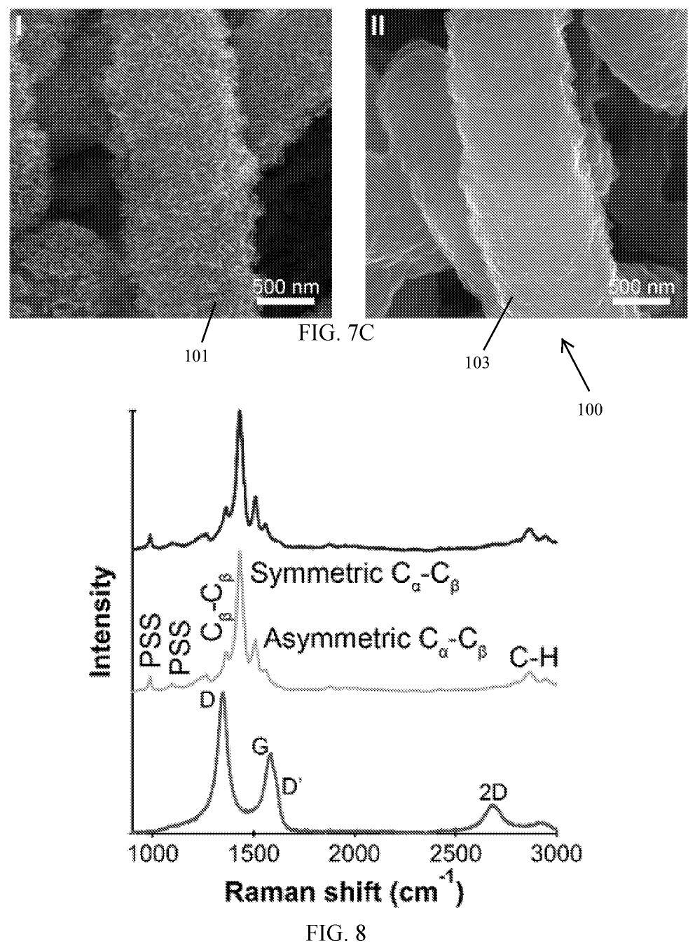

In one embodiment, 3DFG 101 and NT-3DFG is used as a template for conductive polymers, such as poly(3,4-ethylenedioxythiophene) polystyrene sulfonate (PEDOT:PSS), to create hybrid-bioelectronic interfaces with a 3D topology. The PEDOT:PSS is a functional group 103 added to the graphene 101. FIG. 7A is a schematic showing a conventional 2D electrode and a NT-3DFG electrode 110. The PEDOT:PSS is electropolymerized onto NT-3DFG microelectrodes 110 such that individual nanowire is conformally coated with PEDOT:PSS (See FIG. 7B). The size of the electrode in FIG. 7B is around 20 μm. FIG. 7C shows scanning electron microscopy images of NT-3DFG (left) and NT-3DFG with electrodeposited poly(3,4-ethylenedioxythiophene) polystyrene sulfonate (PEDOT:PSS) as a functional group 103 (right).

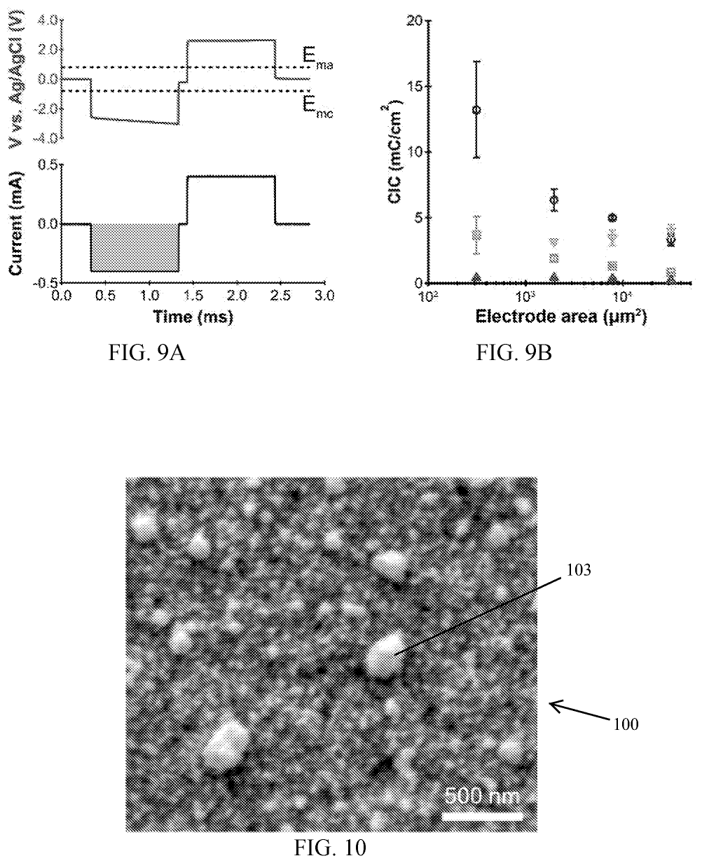

This functionalized hybrid nanomaterial 100 exhibits superior electrochemical performance compared to conventional 2D bioelectronic materials, including lower electrode impedance and high charge injection capacity (CIC). FIG. 8 is a graph depicting the Raman spectra of representative NT-3DFG (bottom line), 2D electrodeposited PEDOT:PSS (middle line), and NT-3DFG with electrodeposited PEDOT:PSS (top line) electrodes 110. Compared with conventional planar metal microelectrodes, NT-3DFG electrodes and PEDOT:PSS-coated NT-3DFG electrodes 110 show up to 35-fold and 125-fold greater CIC, respectively (see FIGS. 9A-9B).

As shown in FIGS. 9A-9B, the 3D topography enhances actuation capabilities of the graphene-based hybrid microelectrodes 110. The graph in FIG. 9A shows voltage transient (top line) of a 200 μm templated-3D fuzzy graphene (NT-3DFG) with electrodeposited poly(3,4-ethylenedioxythiophene) polystyrene sulfonate (PEDOT:PSS) measured as a response to applied biphasic current pulse (bottom line). Shaded region denotes charge injected to the electrode/electrolyte interface. The graph in FIG. 9B is a charge injection capacity (CIC) characterization of Pt (triangles), 2D electrodeposited PEDOT:PSS (inverted triangles), NT-3DFG (boxes), and NT-3DFG with PEDOT:PSS (circles) microelectrode arrays (MEAs) as a function of the geometric area of the electrodes 110. Therefore, NT-3DFG and polymer-coated NT-3DFG, as a functionalized hybrid graphene material 100, enable extending the topology of nanomaterials and push the functional limits of conventional bioelectronics.

Templating Catalyst onto 3DFG and NT-3DFG

Providing a nanoscopic template, the chemically stable 3DFG 101 and NT-3DFG can be decorated with various functional materials 103 for electrocatalyst and biochemical sensing. Thin film deposition, electrodeposition, solvothermal synthesis techniques and small molecule decoration via π-π interaction can be utilized with 3DFG platforms.

### 3D Fuzzy Graphene and Catalysis

3DFG 101 itself is a robust and efficient catalyst for various chemical reactions. For example, the electrochemically active sites of the 3DFG 101 flake edges allow for chemical reactions, such as oxygen reduction reactions (ORR). 3DFG 101 flakes modified with oxygenated functional groups 103 (such as the carbonyl and hydroxyl groups) have highly active sites for two-electron ORR. In addition to the catalytic activities of pristine 3DFG structures, their remarkably large surface area provides abundant potential sites for molecular decoration to reinforce the functionality of the introduced materials 103. Consequently, small molecules 103 which represent catalytic behaviors can be used to decorate the graphene surface. For example, NT-3DFG electrodes 110 have been shown to be easily modified with hemin chloride 103 as well as iron phthalocyanine (FePc) 103 to form effective four-electron oxygen reduction electrocatalysts.

The electrochemical deposition relies on charge transfer of small molecules at the electrode interface; therefore, it can be widely applied to all materials which have redox capabilities such as metal salts, molecules with functional groups, and monomers. For instance, electrodeposited iridium oxide 103 on 3DFG 101 shows superior performances in oxygen evolution reaction (OER) than the thin film on conventional planar metal substrates, lowering the onset potential for OER by 65 mV in comparison to 2D planar catalysts, as shown in FIG. 10. FIG. 10 depicts the surface morphology of a nanoparticle-deposited 3D nanocarbon structure 100. Specifically, the image in FIG. 10 shows an iridium oxide nanoparticle-decorated 3DFG hybrid material 100, which is suitable for catalytic activity in an oxygen evolution reaction. The density of nanoparticle decoration can be fine-tuned by modulating synthesis parameters of 3DFG 101 as well as the electrodeposition methods, for example, applied potential and/or current, deposition time, and the concentration of percursors. Furthermore, the greater number of active sites in 3DFG 101 is beneficial not only in electrocatalysis but also in other catalytic reactions such as photocatalysis.

### 3D Fuzzy Graphene and Selective Interactions

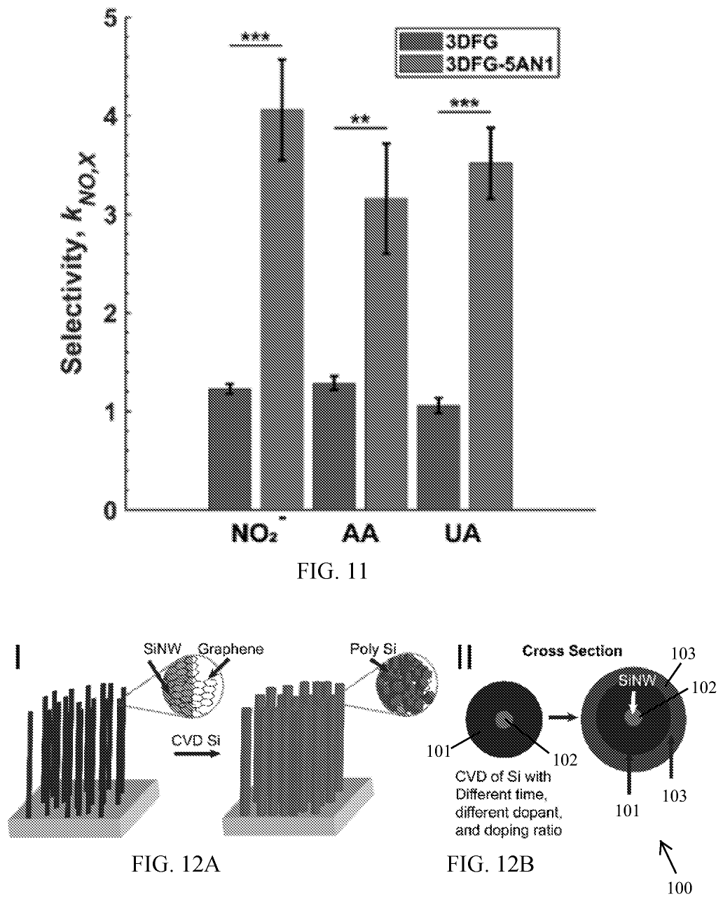

3DFG 101 is a promising platform for biochemical and chemical sensing, due to its high density of active sites and high electrochemical surface area (ECSA). The versatility of surface functionality enables catalyst decoration for improved device sensitivity as well as modification for targeting specific analytes. The surface can also be modified with semipermeable layers for interferent screening to achieve high selectivity toward a specific biological and/or chemical marker. As a result, in one embodiment a 3DFG electrode 101 is electrodeposited with 5-amino-napthol-1 (5AN1) as a functional group 103 to form sensitive and selective sensors towards nitric oxide (NO) in the presence of relevant physiological interferents. FIG. 11 shows the selectivity of 5AN1-functionalized 3DFG sensors 100 to NO versus interferents, before and after electrodeposition of 5AN1. The interferents include nitrite (NO₂⁻), ascorbic acid (AA), and uric acid (UA).

Templating Semiconductors onto NT-3DFG

The high edge-density and high porosity of NT-3DFG leverages the opportunity to template light-responsive semiconducting materials 103 for photoelectrical application. The 3D hierarchical graphene structures allow for thin film deposition via versatile techniques, such as CVD, physical vapor deposition (PVD), sputtering, and atomic layer deposition (ALD).

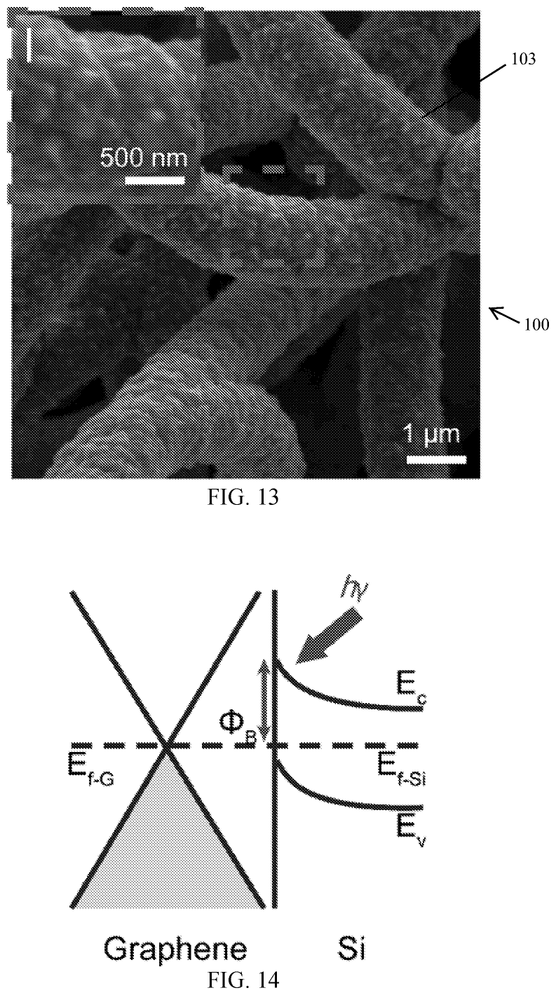

In one embodiment, the hybrid material 100 comprises Si-coated NT-3DFG (Si-NT-3DFG) which has enhanced photothermal and/or photoelectric responses with light pulses. FIGS. 12A-12B show three-dimensional and cross-section schematics of the Si-NT-3DFG process. The NT-3DFG is synthesized following previous described protocol, and Si 103 is synthesized via CVD with SiH₄ precursor with PH₃ (n-type Si) or B₂H₄ (p-type Si). The Si deposition via CVD process on the 3D hierarchy structure results in polycrystalline Si structure 103 and the thickness of the poly-Si layer 103 is a function of deposition time, as shown in FIG. 13. The Si-NT-3DFG depicted in FIG. 13 was produced using a 20 min. n-Si shell synthesis under 60 mTorr SiH₄ with 0.002 doping ratio at 775° C. At 10 minutes, the Si 103 has a diameter of about 0.7 μm and a diameter of about 1.2 μm after 20 minutes. More specifically, a Si-NT-3DFG hybrid material has a quantified diameter of an 800° C., 30 minute synthesized NT-3DFG substrate is 408.3±61.8 nm, 712.6±46.7 nm, and 1123.6±256.4 nm for 0-, 10-, and 20-min synthesis, respectively.

The chemical nature of the carbon flakes and poly-Si can be gleaned from Raman spectroscopy. When photons are absorbed by the junction between graphene 101 and Si 103, photons with energy larger than the bandgap of Si can generate electron-hole pairs, and the photogenerated carriers can be separated under the built-in field. The Si-NT-3DFG material 100 demonstrates both photothermal and photoelectrical current with a single 10 ms laser pulse (FIG. 9). For example, FIG. 14 shows the energy band diagram of a graphene/Si junction at equilibrium, which determines the transfer of photo-generated electron-hole pairs. E_{C}, E_{f-si} and E_{V} are the conduction band, Fermi level, and valence band of Si, respectively. E_{f-G} is the equilibrium Fermi level in graphene, and Φ_{B}=E_{C}−E_{fg} is the Schottky barrier height at equilibrium. The enhanced absorption of the polycrystalline Si functional group 103 also results in increased temperature rise compared with pristine NT-3D1FG. The photo-responsive Si-NT-3DFG has high potential achieve the modulation of electrically active cells and tissues with light pulses.

When used in this specification and claims, the terms “comprises” and “comprising” and variations thereof mean that the specified features, steps, or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents.

What is claimed is:

1. A functionalized hybrid graphene material comprising:
a substrate comprising a nanowire;
graphene disposed on a surface of the nanowire, wherein the graphene comprises single- to few-layer graphene flakes having an out-of-plane topography free-standing on the surface;
a functional group associated with the graphene.

2. The functionalized hybrid graphene material of claim 1, wherein the functional group comprises poly(3,4-ethylenedioxythiophene) polystyrene sulfonate.

3. The functionalized hybrid graphene material of claim 2, wherein the functional group has a three-dimensional topography.

4. The functionalized hybrid graphene material of claim 2, wherein the substrate forms a microelectrode.

5. The functionalized hybrid graphene material of claim 1, wherein the functional group comprises 5-amino-napthol-1.

6. The functionalized hybrid graphene material of claim 5, wherein the hybrid graphene material is adapted to associate with interferents selected from the group consisting of nitrite, ascorbic acid, and uric acid.

7. The functionalized hybrid graphene material of claim 1, wherein the functional group comprises silicon.

8. The functionalized hybrid graphene material of claim 7, wherein the silicon comprises polycrystalline silicon.

9. The functionalized hybrid graphene material of claim 7, wherein the silicon surrounds the graphene and a diameter of the material ranges from about 350 nanometers to 1300 nanometers.

10. The functionalized hybrid graphene material of claim 1, wherein the nanowire comprises silicon.

11. A method of fabricating a functionalized hybrid graphene material comprising:
providing a substrate comprising a silicon nanowire;
forming graphene on the substrate through a chemical vapor deposition process, wherein the graphene has an out-of-plane topology terminating at an end distal from the substrate with single to few-layer graphene flakes;
coating the graphene with silicon in a deposition process.

12. The method of claim 11, further comprising:
energizing the hybrid graphene material to produce a photoelectrical current.

13. The method of claim 11, further comprising:
modulating an electrically active biological cell using a pulse of light on the hybrid graphene material.
